(19) United States
(12) Patent Application Publication
(10) Pub. No.: US 2017/0193786 A1
(43) Pub. Date: Jul. 6, 2017

(54) ELECTRICAL FIRE EARLY DETECTION DEVICE AND METHOD FOR EARLY DETECTION OF ELECTRICAL FIRE IN A METAL CONTAINER

(71) Applicant: Seung Chul Lee, Daejeon (KR)

(72) Inventor: Seung Chul Lee, Daejeon (KR)

(21) Appl. No.: 15/370,979

(22) Filed: Dec. 6, 2016

(30) Foreign Application Priority Data
Dec. 30, 2015 (KR) 10-2015-0189329

(51) Int. Cl. G08B 17/117

(52) U.S. Cl. CPC G08B 17/117

(57) ABSTRACT

An electrical fire early detection device and method for early detection of an electrical fire in a metal container are disclosed. The device includes an upper sensor that detects a concentration of a gas in an upper portion of the metal container; a lower sensor that detects a concentration of the gas in a lower portion of the metal container; and a controller that determines whether there is an electrical fire or not on the basis of the concentrations of the gas in the upper and lower portions of the metal container and a critical value representing an index of a gas fire. The device and method detect BHT gas, generated due to heat transferred to a themoplastic plastic material, as a target gas.

### BACKGROUND

The present disclosure relates to an electrical fire early detection device and method for early detection of an electrical fire in a metal container. More particularly, the present disclosure relates to a technology for early detection of an electrical fire in a metal container by detecting BHT gas, generated due to heat transferred to a themoplastic plastic material, as a target gas.

A metal container for a high voltage distribution board, a low voltage distribution board, a power panel, or a cabinet panel contains electrical equipment for supplying electrical power.

Electrical equipment includes electrical conductors that transfer electric power, and the electrical conductors are joined to each other by a nut and bolt. In addition, electrical conductors are usually coated with an electrically insulating material such as robber or vinyl to protect electricians from electric shocks or to prevent short-circuiting between the electrical conductors.

Conventionally, gas sensors are responsive to various gases such as benzene, alcohol, and butylated hydroxy toluene (BHT) gas generated when electrically insulating materials or support members covering electrical conductors undergo the thermal decomposition. Therefore, conventionally, it was difficult to accurately detect a sign of an electrical fire with the use of a gas sensor.

Furthermore, conventionally, a gas sensor is usually arranged at a center portion in a metal container containing electrical equipment therein to detect the concentration of a gas. However, the concentration of a gas varies according to places in which a metal container with electrical equipment therein is installed. That it, the concentration of a gas varies according to whether a metal container is installed in an indoor space, an outdoor space, or an underground space. In addition, the concentration of a gas may vary according to ambient temperatures or humidity. Therefore, it is difficult to obtain a reliable value of the concentration of a gas with the use of conventional technologies.

### SUMMARY

Embodiments of the present disclosure provide an electrical fire early detection device for early detection of an electrical fire in a metal container by clearly detecting a sign of an electrical fire, through formation of a themoplastic plastic material on the surface of a nut and bolt used to join electrical conductors to each other and through detection of a target gas (BHT gas) generated from the thermoplastic plastic material when the electrical conductors are heated.

Embodiments also provide an electrical fire early detection device for reliably and promptly detecting an electrical fire in a metal container by installing an upper sensor and a lower sensor that detect BHT gas, in an upper portion and a lower portion of the metal container and by determining that there is an electrical fire when the concentration of the BHT gas detected by the upper sensor is higher than the concentration of the BHT gas detected by the lower sensor.

One embodiment provides an electrical fire early detection device for early detection of an electrical fire in a metal container, the device including: a Butylated Hydroxy Toluene (BHT) gas generating portion formed on a contact portion between electrical conductors; an upper sensor detecting BHT gas in an upper portion of the metal container; a lower portion detecting BHT gas in a lower portion of the metal container; and a controller that determines whether there is an electrical fire in the metal container by comparing concentrations of the BHT gas detected in the upper portion and the lower portion of the metal container with a critical value representing an index of a gas fire.

The BHT gas generating portion may comprise a themoplastic plastic material containing BHT filled in a hole formed in a nut or bolt that joins terminals of the electrical conductors to each other.

The controller may determine that there is an electrical fire when the concentration of a gas detected in the upper portion in which an internal temperature of the metal container more quickly rises than the other portions is higher than the concentration of the gas detected in the lower portion into which outdoor air is introduced.

The upper sensor may be installed in an upper air vent formed at an upper portion of a rear surface of the metal container and the lower sensor may be installed in a lower air vent formed at a lower portion of the rear surface of the metal container.

The upper and lower sensors may detect a change in electrical resistance that changes in accordance with gas concentrations and may measure an electrical current change from the detected electrical resistance change.

The electrical fire early detection device for early detection of an electrical fire in the metal container may further include an amplifier that amplifies the electrical current change and an AD converter that converts the amplified electrical current change into a digital signal.

The controller may generate control commands related to safety, caution and warning, and power shutdown in accordance with gas concentrations.

The electrical fire early detection device for early detection of an electrical in the metal container may further include a command providing unit that provides at least one of the control commands to at least one of a circuit breaker, an alarm, a flashing lamp, a management server, and a manager's terminal.

Another embodiment provides an electrical fire early detection method for early detection of an electrical fire in a metal container by detecting a target gas that is BHT gas generated due to heating of a contact portion between electrical conductors, the contact portion being covered by a thermoplastic plastic material containing BHT, the method including: measuring a first electrical current change by detecting a change in electrical resistance that changes in accordance with gas concentrations in an upper portion of the metal container with use of an upper sensor, and measuring a second electrical current change by detecting a change in electrical resistance that changes in accordance with gas concentrations in a lower portion of the metal container with use of a lower sensor; amplifying and converting the first electrical current change and the second electrical current change into a first digital signal and a second digital signal, respectively; and determining whether there is an electrical fire in the metal container on the basis of the first and second digital signals and a critical value representing an index of a gas fire.

According to the present disclosure, since BHT gas, generated prior to combustion of a thermoplastic plastic material covering the surface of a nut or bolt that joins electrical conductors to each other, is detected as a target gas, it is possible to precisely and accurately detect a sign of an electrical fire.

Since an upper sensor and a lower sensor for detecting BHT gas are installed in an upper portion and a lower portion in a metal container, respectively in consideration of surrounding environment of the metal container, and since it is determined that there is an electrical fire when the concentration of a gas detected by the upper sensor is higher than the concentration of the gas detected by the lower sensor, it is possible to accurately detect a sign of an electrical fire.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a block diagram illustrating an electrical fire early detection device for early detection of an electrical fire in a metal container, according to an embodiment;

FIG. 2A is a rear view illustrating a rear surface of the electrical fire early detection device according to an embodiment;

FIG. 2B is a cross-sectional view illustrating the electrical fire early detection device according to an embodiment;

FIGS. 3A to 3C are graphs illustrating the analysis results of pyrolysis gas chromatography for an electric cable;

FIGS. 4A to 4C are graphs illustrating the analysis results of pyrolysis gas chromatography for a tube;

FIGS. 5A to 5C are graphs illustrating the analysis results of pyrolysis gas chromatography for a terminal strip; and

FIG. 6 is a flowchart illustrating an electrical fire early detection method for early detection of an electrical fire in a metal container, according to another embodiment.

### DETAILED DESCRIPTION

Hereinafter, one or more embodiments will be described with reference to the accompanying drawings but are not to be construed as the limit of the present disclosure.

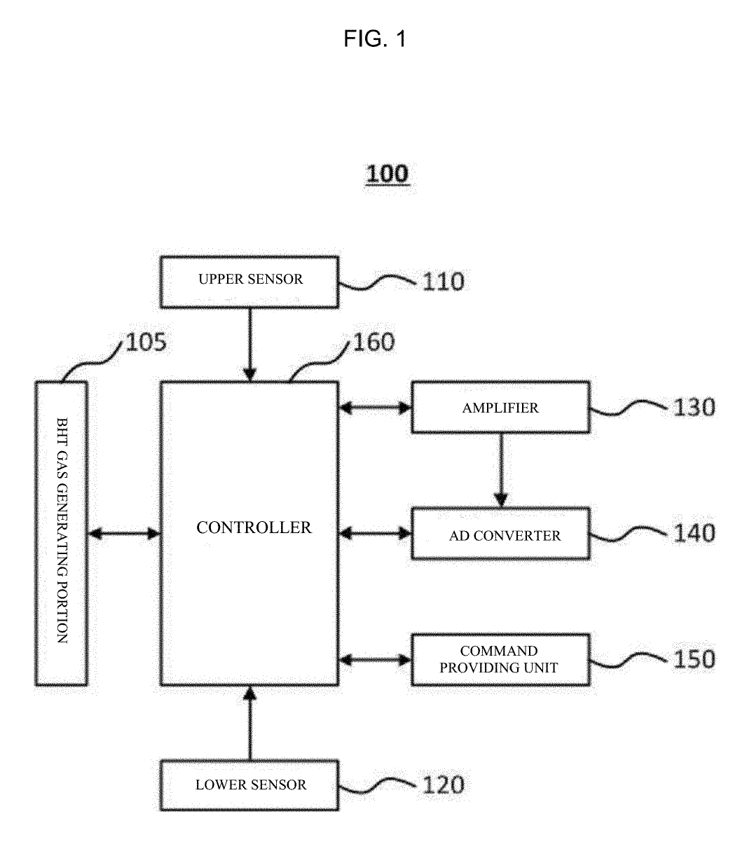

FIG. 1 is a block diagram illustrating an electrical fire early detection device for early detection of an electrical fire in a metal container, according to one embodiment. An electrical fire early detection device 100 for early detection of an electrical fire in a metal container, according to one embodiment, includes a BHT gas generating portion 105, an upper sensor 110, a lower sensor 120, and a controller 160. The electrical fire early detection device 100 detects BHT gas, generated from a thermoplastic plastic material when heat is transferred thereto, as a target gas with the use of the upper sensor 110 and the lower sensor 120.

The metal container encases electrical equipment such as a high voltage distribution board, a low voltage distribution board, a power panel, or a cabinet panel that supplies power and is made of a metallic material or a fiber reinforced plastic material.

Korean Patent No. 10-0981232 discloses a device that detects various gases such as formaldehyde, dioxin, benzene, carbon gas, and BHT gas that are generated from an electrically insulating material. Meanwhile, the electrical fire early detection device according to the present disclosure detects only BHT gas as a target gas to improve accuracy of detection of an electrical fire.

The BHT gas generating portion 105 is provided on a contact portion between electrical conductors. The BHT gas generating portion 105 may comprise a thermoplastic plastic material containing BHT filled in a hole formed in a nut or bolt used to join electrical conductors to each other.

The thermoplastic plastic material may be arranged in a hole formed in the head of a bolt, a gap between a contact portion of an electrical conductor and a bolt that fixes the contact portion, or a hole formed in a nut.

The upper sensor 110 detects a gas in an upper portion in the metal container, and the lower sensor 120 detects a gas in a lower portion in the metal container. The upper sensor 110 and the lower sensor 120 may detect BHT gas generated from the thermoplastic plastic material containing BHT when heat from a bolt is transferred thereto.

The upper sensor 110 and the lower sensor 120 are sensitive to various gases such as benzene, alcohol, and BHT gas but can most promptly sense BHT gas. The BHT gas is a target gas to be detected by the upper and lower sensors.

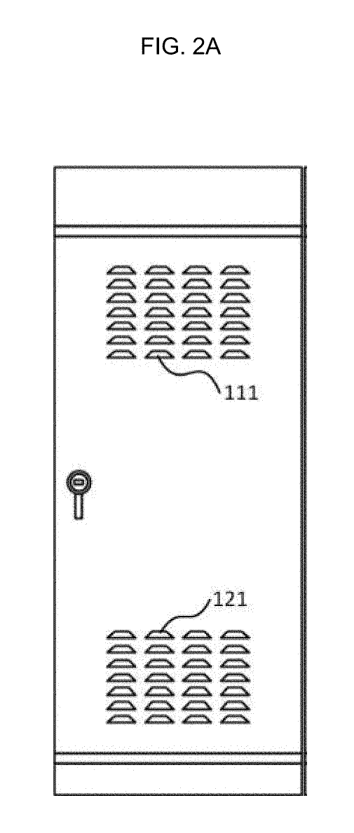

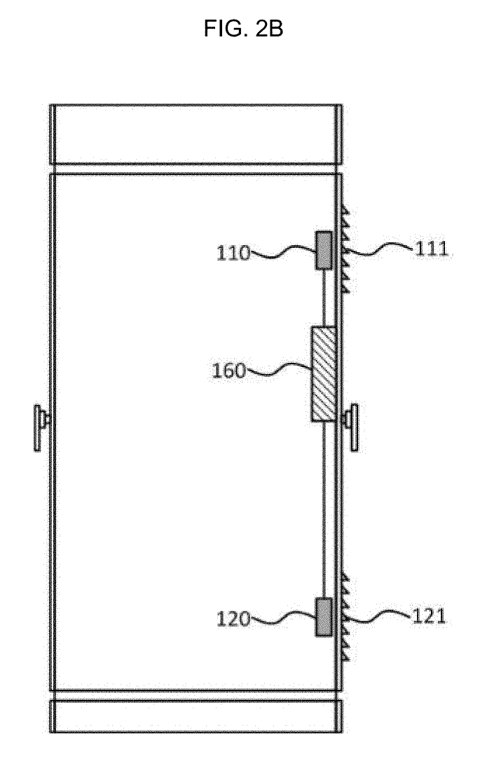

FIG. 2A illustrates a rear surface of the electrical fire early detection device for early detection of an electrical fire in a metal container, according to one embodiment of the present disclosure. FIG. 2B is a cross-sectional view of the electrical fire early detection device according to the embodiment.

With reference to FIGS. 2A and 2B, the upper sensor 110 is installed in an upper air vent 111 arranged at an upper portion of the rear surface of the metal container and the lower sensor 120 is installed in a lower air vent 121 arranged at a lower portion of the rear surface of the metal container.

The upper and lower sensors 110 and 120 may detect a change in electrical resistance that changes in accordance with gas concentrations and measure an electrical current change from the detected electrical resistance change. The electrical current change is a kind of analog signal.

The upper sensor 110 measures a first electrical current change by detecting a change in electrical resistance that changes in accordance with gas concentrations in the upper portion, and the lower sensor 120 measures a second electrical current change by detecting a change in electrical resistance that changes in accordance with gas concentrations in the lower portion.

Korean Patent No. 10-0981232 discloses a device using three gas sensors installed in an upper portion, a middle portion, and a lower portion, respectively. However, according to one embodiment of the present disclosure, two sensors are installed respectively in an upper portion and a lower portion, so that production costs can be reduced. In addition, sensors can be quickly installed and set regardless of gas concentrations in a metal container, in various sites in which the metal container is installed.

With reference to FIG. 1, the electrical fire early detection device 100 for early detection of an electrical fire in a metal container may further include an amplifier 130 that amplifies an electrical current change and an AD converter 140 that converts the amplified electrical current change into a digital signal.

The amplifier 130 amplifies the first electrical current change and the second electrical current change, and the AD converter 140 changes the amplified first electrical current change and the amplified second electrical current change into a first digital signal and a second digital signal, respectively.

The controller 160 determines whether there is an electrical fire or not in a metal container, on the basis of the concentrations of the BHT gas in the upper portion and the lower portion of the metal container and of a critical value representing an index of a gas fire.

Alternatively, the controller 160 may determine whether there is an electrical fire or not in a metal container, on the basis of the first and second digital signals detected in the upper and lower portions of the metal container and of a critical value representing an index of a gas fire.

Specifically, the controller 160 may determine that there is a sign of an electrical fire when gas concentrations of the first and second digital signals are higher than the critical value or when the average of the gas concentrations of the first and second digital signals is higher than the critical value.

Alternatively, the controller 160 may determine that there is a sign of an electrical fire when the gas concentration detected in the upper portion is higher than the gas concentration detected in the lower portion.

Response characteristics of gas sensors may vary according to surrounding environments in which the metal container is installed. In addition, outdoor air may be introduced into the metal container through the lower air vent or indoor air may be discharged outside the metal container through the upper air vent, according to temperatures in the metal container. For this reason, the controller 160 may determine that there is an electrical fire in the metal container when the gas concentration detected in the upper portion is higher than the gas concentration detected in the lower portion.

While Korean Patent No. 10-0981232 discloses a device using three sensors that detect a gas concentration in an upper portion, a middle portion, and a lower portion in a metal container, the device of the present disclosure does not include a sensor installed in a middle portion at which the senor unstably operates or easily malfunctions. The device of the present disclosure determines an electrical fire in a metal container when the gas concentration detected in the upper portion of the metal container is higher than the gas concentration detected in the lower portion of the metal container, to prevent a detection error attributable to unstable operation or malfunctioning of the sensor.

The controller 160 can generate control commands related to “safety”, “caution and warning”, and “power shutdown” according to concentrations of the BHT gas and can refer to critical values that are classed according to concentrations of the BHT gas.

The electrical fire early detection device 100 may further include a command providing unit 150 that provides one of the control commands to at least one of a circuit breaker, an alarm, a light flashing lamp, a management server, and a manager's terminal.

For example, the command providing unit 150 may receive one of the control commands from the controller 160 and transmit a control signal representing the control command “power shutdown” to a circuit breaker installed in the metal container. Alternatively, the command providing unit 150 may transmit an alarm signal or a flashing signal representing the control command “caution and warning” to the alarm or the flashing lamp. Alternatively, the command providing unit 150 can perform its own control command.

The command providing unit 150 may include a wireless or wired communication module and thus can send a message containing any one of the control commands to at least one of the management server and the manager's terminal through the wireless or wired communication module.

In the electrical fire early detection device 100 for early detection of an electrical fire in a metal container, according to the present embodiment, a bolt is used to connect electrical conductors to each other. Therefore, the themoplastic plastic material is inserted in a hole formed in the head of the bolt, and the BHT gas generated due to heat transferred from the bolt is detected as a target gas. Hereinafter, the reason that the BHT gas is detected as a target gas will be described with reference to the analysis results of pyrolysis-gas chromatography.

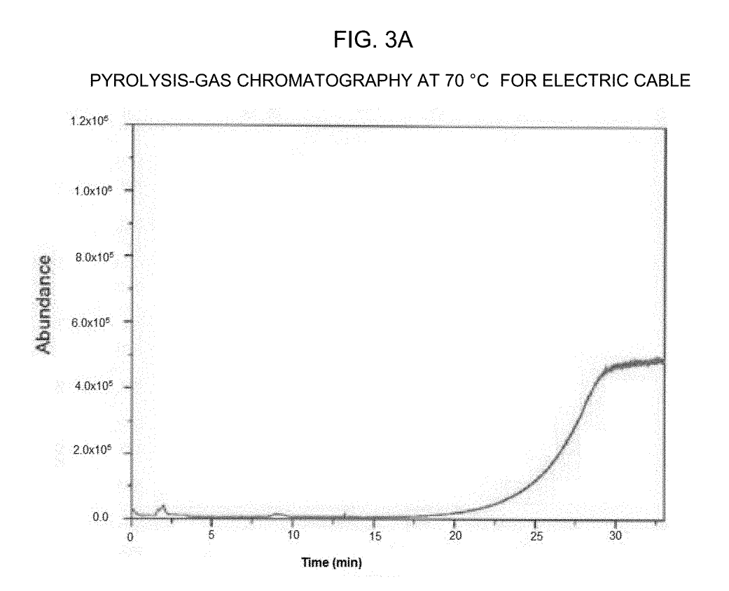

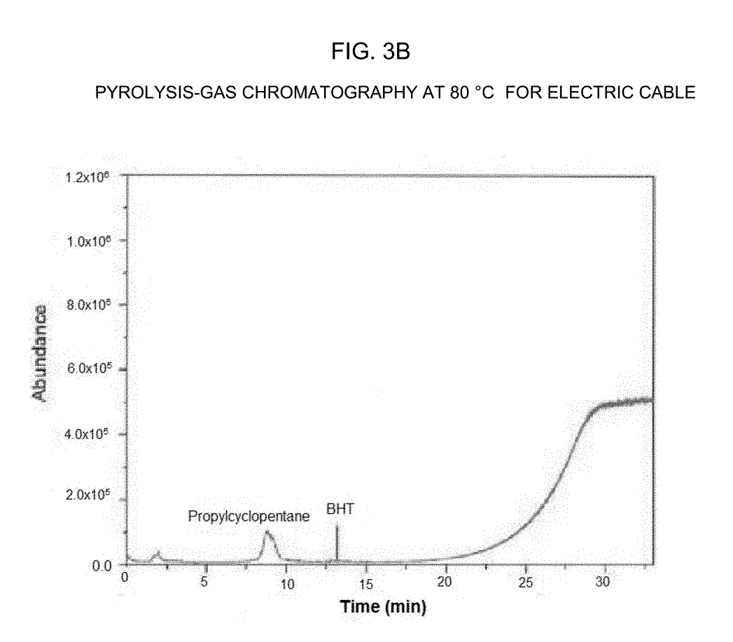

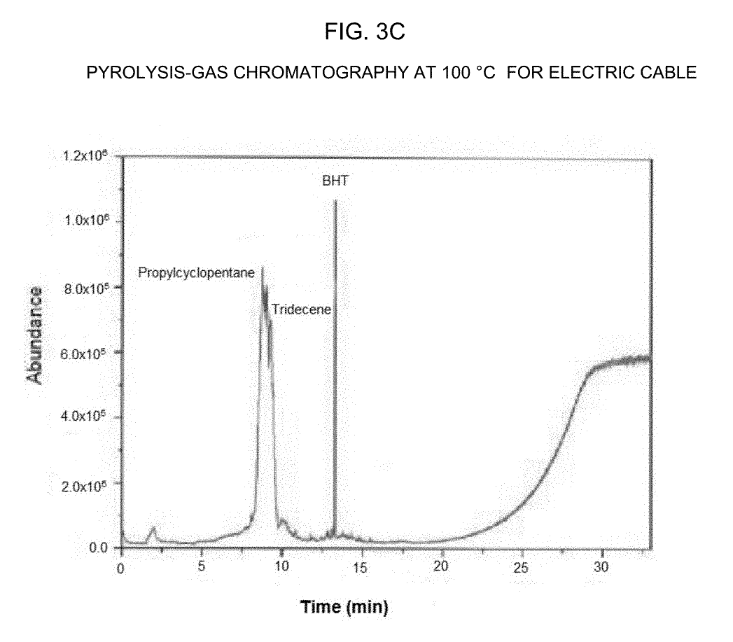

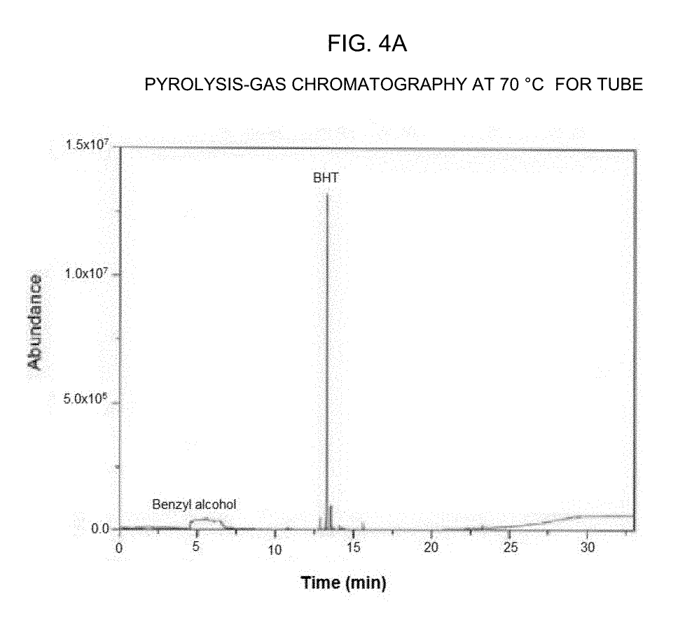

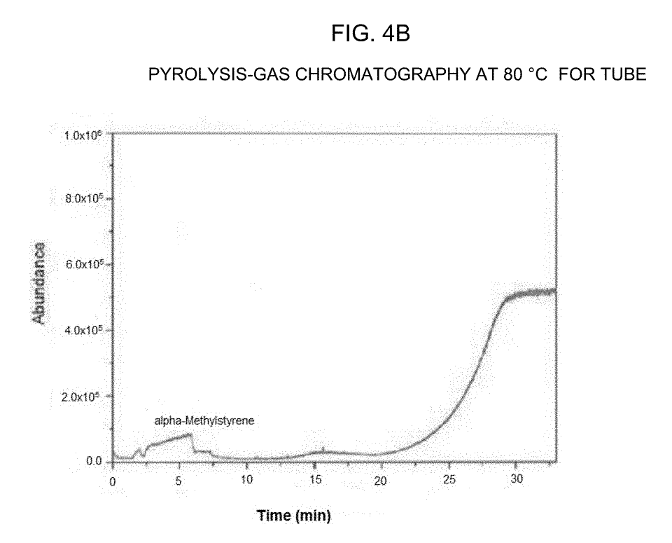

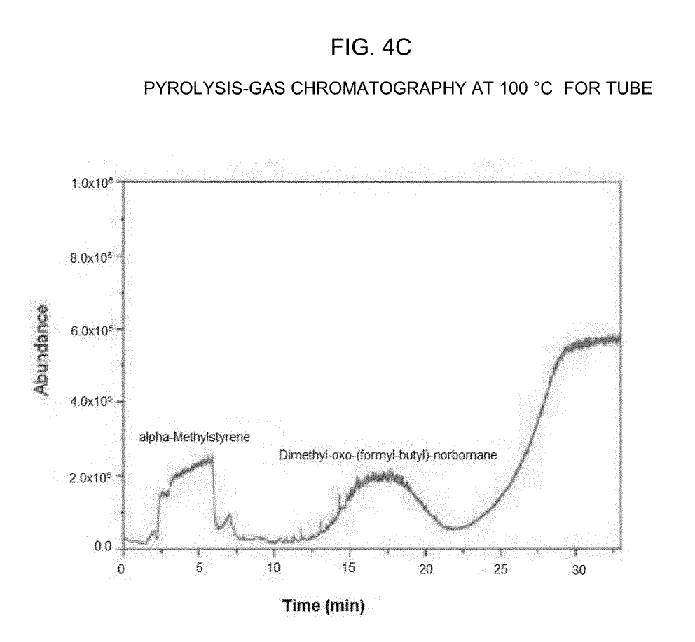

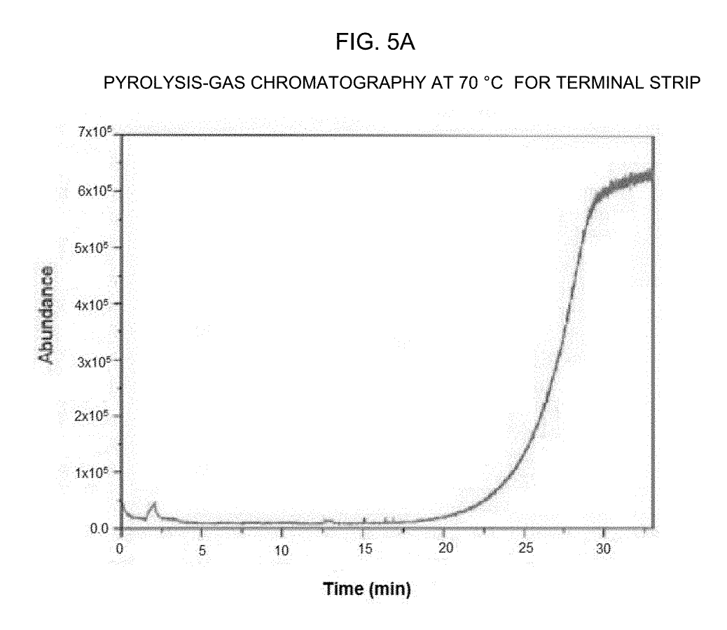

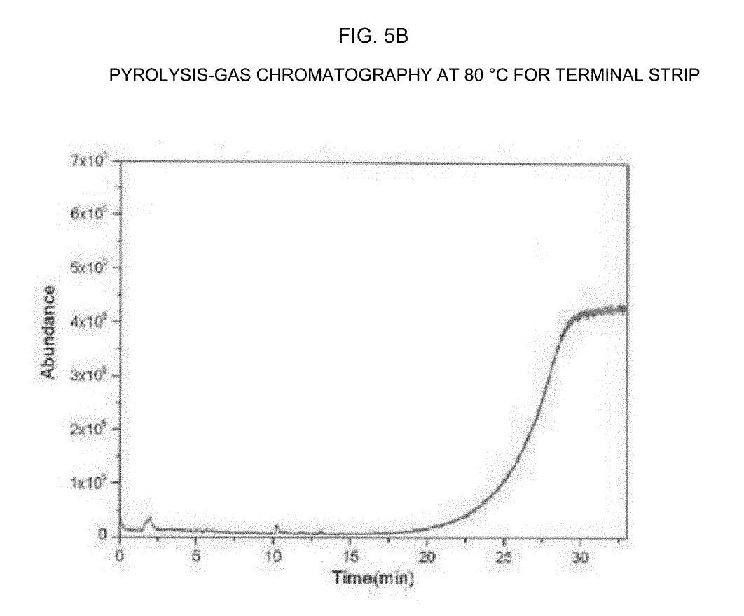

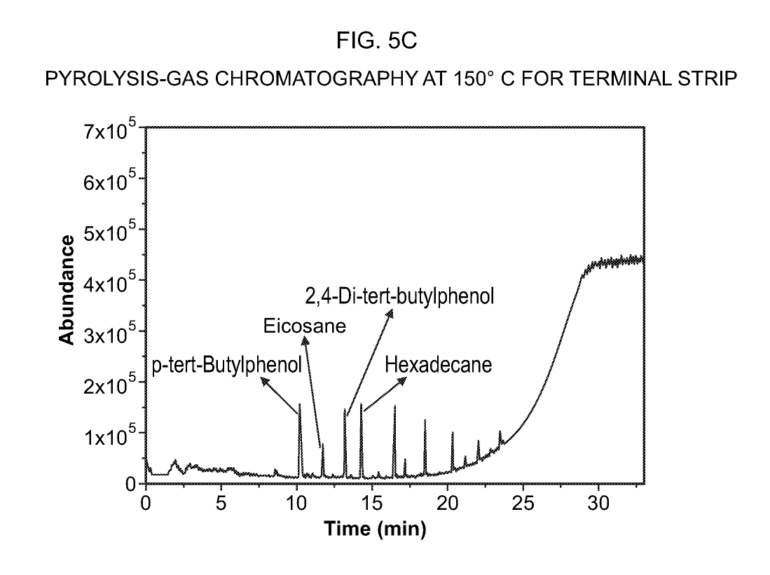

FIGS. 3A to 3C show the analysis results of pyrolysis-gas chromatography for an electric cable. FIGS. 4A to 4C show the analysis results of pyrolysis-gas chromatography for a tube. FIGS. 5A to 5C show the analysis results of pyrolysis-gas chromatography for a terminal strip.

Through the pyrolysis-gas chromatography, components of a gas that was generated from an electric cable, a tube, or a terminal strip when heat was generated in a metal container were analyzed with the use of a pyrolyzer. For the pyrolysis-gas chromatography, pyrolysis was performed at predetermined temperatures for 10 minutes. Specifically, the temperature was incrementally increased at a rising rate of 10° C./min within a temperature range of from 50° C. to 320° C., and a capillary column, in which stationary phases were composed of 5% disphenyl and 95% dimethylpolysiloxane, was used.

An insulating covering material of the electric cable, tube, and terminal strip was made of a thermoplastic plastic material that undergoes plastic deformation when heat is applied thereto.

The electric cable included an insulating covering material that covers an electric wire through which an electric current flows. The tube included an insulating covering material that insulates an electrical conductor such as a terminal (for example, a crimp-style copper terminal) that connects an end of an electric wire to an electrical conductor. The terminal strip included an insulating covering material that fixes electrical conductors connected by a crimp-style terminal.

With reference to FIGS. 3A to 3C, the electric cable generated various kinds of gases when heated. The kinds of gases generated were similar at any temperatures but the amounts of gases vary according to temperatures. For example, the amounts of the gases differ at 70° C., 80° C., and 100° C. That is, propylcyclopentane was generated at a time point of 8.8 minutes, and BHT was generated at a time point of 13.3 minutes. BHT is an additive that serves as an antioxidant and is blended in a thermoplastic plastic material. When a thermoplastic plastic material is heated, BHT is emitted in the form of a gas.

With reference to FIGS. 4A to 4C, the amounts of gases dramatically increased as the temperature increased from 70° C. to 80° C. to 100° C. Although the amounts of gases changed, the kinds of gases generated were similar even with the temperature changes. Specifically, benzyl alcohol was generated at a time point of 5 or 6 minutes, BHT gas was generated at a time point of 13.2 minutes, and BHT-quinone-methide that is a converted gas of BHT gas was generated at a time point of 12.8 minutes. Benzyl alcohol is an organic solvent.

With reference to FIGS. 5A to 5C, the terminal strip generated nearly no gas at 100° C. and 130° C. but generated various kinds of gases at 150° C. Specifically, phenol-based gases were generated at a time point of 10.2 minutes, a time point of 13.2 minutes, and a time point of 17.2 minutes. In addition, aliphatic hydrocarbons were generated at time points of 10.3 minutes, 11.7 minutes, 14.2 minutes, 16.4 minutes, 18.5 minutes, and 20.3 minutes. The phenol-based gases were generated due to antioxidants such as BHT or due to gasification of phenol resins.

In the gas chromatography analysis, the electric cable, tube, and terminal strip generated different kinds of gases at different temperatures but they all generated BHT gas in common due to thermal decomposition of a thermoplastic plastic material.

According to the present disclosure, since BHT gas that is generated from a thermoplastic plastic material is detected as a target gas, accuracy of gas detection can be improved. Furthermore, it is possible to accurately detect a sign of an electrical fire by promptly detecting a gas generated due to heating or contact failure of a bolt having a hole that is formed in the head thereof and filled with a themoplastic plastic material.

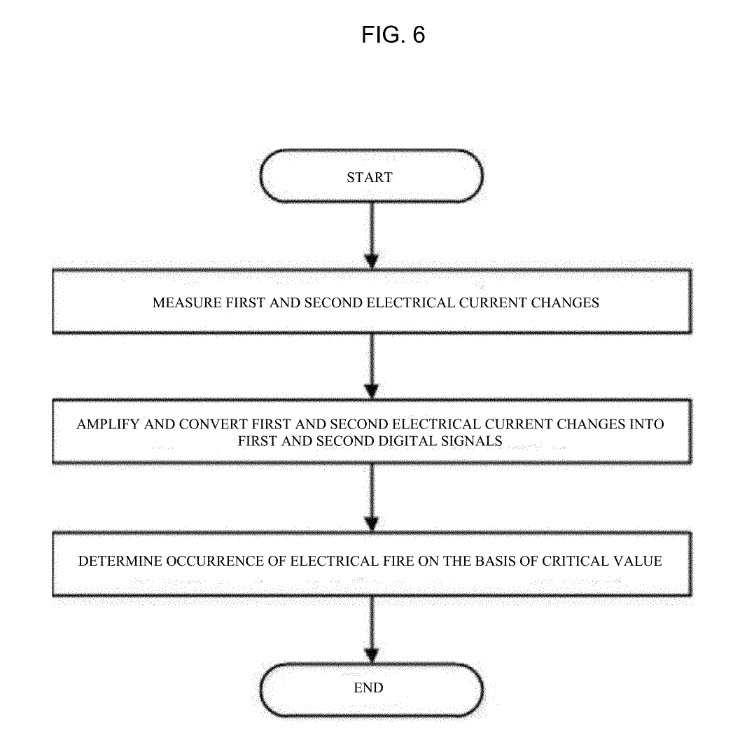

FIG. 6 is a flowchart illustrating an electrical fire early detection method for early detection of an electrical fire in a metal container. The method detects a target gas that is BHT gas, which is generated due to heating of a contact portion covered by a BHT-contained thermoplastic plastic material, by detecting a change in electrical resistance that changes in accordance with gas concentrations in an upper portion of a metal container with the use of an upper sensor to measure a first electrical current change and by detecting a change in electrical resistance that changes in accordance with gas concentrations in a lower portion of the metal container with the use of a lower sensor to measure a second electrical current change.

In the electrical fire early detection method for early detection of an electrical fire in a metal container, the first and second electrical current changes are amplified and converted into a first digital signal and a second digital signal, respectively. In addition, a determination of whether there is an electrical fire or not in a metal container is made based on the first and second digital signals and a critical value representing an index of a gas fire.

The electrical fire early detection method of detecting an electrical fire in a metal container determines that there is an electrical fire when the concentration of BHT gas detected in the upper portion of the metal container is higher than the concentration of BHT gas detected in the lower portion of the metal container.

What is claimed is:

1. An electrical fire early detection device for early detection an electrical fire in a metal container, the electrical fire early detection device comprising:
a butylated hydroxy toluene (BHT) gas generating portion formed on a contact portion between electrical conductors;
an upper sensor installed in an upper portion in the metal container, to detect a concentration of BHT gas in the upper portion of the metal container;
a lower sensor installed in a lower portion in the metal container, to detect a concentration of the BHT gas in the lower portion of the metal container; and
a controller determining whether there is an electrical fire or not by comparing the concentrations of the BHT gas detected in the upper and lower portions of the metal container with a critical value representing an index of an electrical fire,
wherein the controller determines that there is an electrical fire when the concentration of the BHT gas detected in the upper portion in which an internal temperature of the metal container more quickly rises than the other portions is higher than the concentration of the BHT gas detected in the lower portion into which outdoor air is introduced.

2. The electrical fire early detection device according to claim 1, wherein the BHT gas generating portion comprises a themoplastic plastic material containing BHT filled into a hole formed in a nut or bolt that joins contact terminals of electrical conductors to each other.

3. The electrical fire early detection device according to claim 1, wherein the upper sensor is installed in an upper air vent formed at an upper portion of a rear surface of the metal container and the lower sensor is installed in a lower air vent formed at a lower portion of the rear surface of the metal container.

4. The electrical fire early detection device according to claim 1, wherein the upper and lower sensors detect a change in electrical resistance that changes in accordance with gas concentrations and measure an electrical current change from the detected electrical resistance change.

5. The electrical fire early detection device according to claim 4, further comprising:
an amplifier that amplifies the electrical current change; and
an AD converter that converts the amplified electrical current change into a digital signal.

6. The electrical fire early detection device according to claim 1, wherein the controller generates control commands related to safety, caution and warning, and power shutdown, in accordance with gas concentrations.

7. The electrical fire early detection device according to claim 6, further comprising a command providing unit that provides any one of the control commands to at least one of a circuit breaker, an alarm, a flashing lamp, a management server, and a manager's terminal.

8. An electrical fire early detection method for early detection of an electrical fire in a metal container by detecting BHT gas as a target gas, the BHT gas being generated due to heating of a contact portion between electrical conductors, the contact portion being covered by a thermoplastic plastic material containing BHT, the method comprising:
measuring a first electrical current change by detecting a change in electrical resistance that changes in accordance with gas concentration in an upper portion of the metal container with use of an upper sensor, and measuring a second electrical current change by detecting a change in electrical resistance that changes in accordance with gas concentration in a lower portion of the metal container with use of a lower sensor;
amplifying and converting the first electrical current change and the second electrical current change into a first digital signal and a second digital signal, respectively; and
determining whether there is an electrical fire or not on the basis of the first and second digital signals and a critical value representing an index of a gas fire.
